(19) United States
(12) Patent Application Publication
(10) Pub. No.: US 2008/0233338 A1
(43) Pub. Date: Sep. 25, 2008

(54) Fabricating method for cover of portable electronic device and related portable electronic device utilizing the same

(75) Inventor: Sheng-Yu Tsai, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTek COMPUTER INC

(21) Appl. No.: 11/979,689

(22) Filed: Nov. 7, 2007

(30) Foreign Application Priority Data
Mar. 19, 2007 (TW) 096109385

(51) Int. Cl. B32B 5/00; B29C 65/48

(52) U.S. Cl. 428/98; 156/293; 361/679

(57) ABSTRACT

The present invention provides a fabricating method for a cover of a portable electronic device. The fabricating method includes the following steps of: (a) providing a chunk of timber laminate having an exterior circumferential surface, a first surface, and a second surface, and forming a recess on the second surface; (b) attaching a supporting component into the recess; and (c) cutting the first surface and the exterior circumferential surface to a preset thickness; wherein the first surface and a portion of the exterior circumferential surface expose different woodgrain patterns. A portable electronic device utilizing the above mentioned fabricating method for a cover is also provided.

### BACKGROUND OF THE INVENTION

1. Field of the Invention

The present invention relates to a fabricating method for a cover of a portable electronic device, and more particularly, to a fabricating method for a cover of a portable electronic device and the related portable electronic device utilizing the same.

2. Description of the Prior Art

In the prior art, woodgrain slices are commonly utilized to cover the outside surfaces of components in a slice-veneering manner for forming the woodgrain patterns on the appearance of the components, thereby generating woodgrain products, such as slice-veneered furniture and slice-veneered sound cases.

However, it is often hard to apply slice-veneering technology to an uneven surface. Besides, woodgrain slices attached to the components often become warped or deformed after a period of time due to aging of adhesives, thereby causing the problem that the slice-veneered components cannot be tightly stuck onto those components made of materials different from the woodgrain slices. Moreover, genuine craft features of timber with a nice and warm feel quite different from a cold metal feel is not feasible using the slice-veneering technology.

Although solid wood can also be utilized to make covers for components, it may violate the principles of environmental protection because lots of trees should be cut down for supplying sufficient solid wood in mass production. Additionally, most solid wood needs to be processed for softening its fibers, and its shape needs to be processed to fit that of the components by pressing molding technology. The whole process takes lots of time and efforts.

A bamboo laminate is a large-sized bamboo plate made by gluing small-sized original bamboo plates together along a woodgrain direction. The bamboo laminate thus made cannot be easily deformed or broken, and it has more elasticity and bending strength than original bamboo does. Therefore, the bamboo laminate is a very appropriate material for most and various processing methods.

### SUMMARY OF THE INVENTION

The present invention discloses a fabricating method for a cover of a portable electronic device, comprising the following steps of: (a) providing a chunk of timber laminate having an exterior circumferential surface, a first surface, and a second surface, and forming a recess on the second surface; (b) attaching a supporting component into the recess; and (c) cutting the first surface and the exterior circumferential surface to a preset thickness; wherein the first surface and a portion of the exterior circumferential surface expose different woodgrain patterns.

The present invention also discloses a portable electronic device, comprising: a cover having a supporting component; a display unit; and a body having an input unit; wherein the supporting component is disposed between the cover and the display unit, the display unit is electrically connected to the body, and the cover is fabricated by the following steps of: (a) providing a chunk of timber laminate having an exterior circumferential surface, a first surface, and a second surface, and forming a recess on the second surface; (b) attaching the supporting component into the recess; and (c) cutting the first surface and the exterior circumferential surface to a preset thickness; wherein the first surface and a portion of the exterior circumferential surface expose different woodgrain patterns.

In a preferred embodiment of the present invention, the timber laminate is preferably a bamboo laminate, and the portion of the exterior circumferential surface preferably exposes a transectional woodgrain pattern of the timber laminate. Besides, in the fabricating method of the present invention, the step (b) preferably adhesively attaches the supporting component into the recess, and the step (a) preferably forms the recess by milling. Additionally, in a preferred embodiment of the present invention, the milling in the step (a) and the cutting in the step (c) are preferably performed by a computer numerical control (CNC) machine. Moreover, the material of the supporting component is not limited. The supporting component can preferably be made of metals, plastic steels, or plastics. Additionally, in a preferred embodiment of the present invention, the preset thickness in the step (c) is not limited and can be varied according to the requirements. To achieve lightness, slimness, and sufficient stress resistance of the electronic device, the timber laminate is preferably cut to a thickness between 0.3 mm and 1.5 mm.

Furthermore, the portable electronic device disclosed in the present invention is not limited. In a preferred embodiment of the present invention, the portable electronic device is a notebook computer. The appearance of the portable electronic device in the present invention displays the transectional woodgrain pattern of the timber laminate and exposes dot-shaped vessels. The vessels are natural structures contained in the timber laminate. Contrarily, woodgrain slices utilized by slice-veneering technology in the prior art cannot display any natural vessel as described above. Additionally, timber is utilized as one of the materials for the cover of the electronic device in the present invention. Thus, the electronic device can maintain lightness and slimness while the cover can still achieve the purpose of protecting the electronic device. Additionally, in the electronic device of the present invention, the exterior circumferential surface of the timber laminate used as a part of the cover can be cut to form a right angle or have a preset obliquity according to the requirements. With such obliquity, the edges of the cover can be smoother, and the transection of the natural vessels contained in the timber laminate is much clear, thereby displaying craft features of the electronic device.

In a preferred embodiment of the portable electronic device in the present invention, the cover made of the timber laminate can cover the supporting component properly and completely. Thus, the supporting component cannot be easily seen from the outside. Additionally, in the timber laminate, the portion that is adhesively attached to the supporting component may contain various shapes with different thicknesses. On the appearance of the electronic device, the timber laminate can have different kinds of shapes in accordance with practical requirements. In the electronic device of the present invention, the supporting component can expose specific patterns or words by milling the timber laminate to form various shapes with different thicknesses, thereby upgrading practicability of the electronic device having the cover made by the fabricating method as disclosed above.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a portable electronic device of the present invention.

FIG. 2 is a schematic diagram illustrating a bamboo laminate of the present invention and a processing step on the bamboo laminate.

FIG. 3 is a schematic diagram illustrating a supporting component of the present invention and a adhering step for connecting the supporting component to the bamboo laminate.

FIG. 4 is a schematic diagram illustrating a processing step after the supporting component is connected to the bamboo laminate in the present invention.

### DETAILED DESCRIPTION

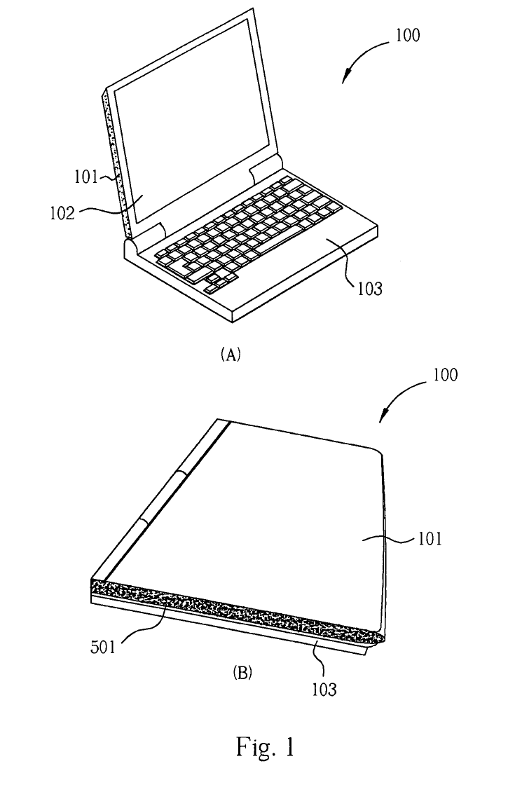

An embodiment of a fabricating method for a cover of a portable electronic device in the present invention is described in details as follows. In this embodiment, the portable electronic device is a notebook computer. As shown in FIGS. 1(A)-1(B), the notebook computer 100 typically comprises a cover 101, a display unit 102, and a body 103. The cover 101 has a supporting component (as described below), and the body 103 has an input unit (e.g. a keyboard shown in FIG. 1). Additionally, the supporting component is disposed between the cover 101 and the display unit 102, and the display unit 102 is electrically connected to the body 103. In this embodiment of the fabricating method, a bamboo laminate is utilized as one of the materials for the cover 101 of the notebook computer 100 in the present invention.

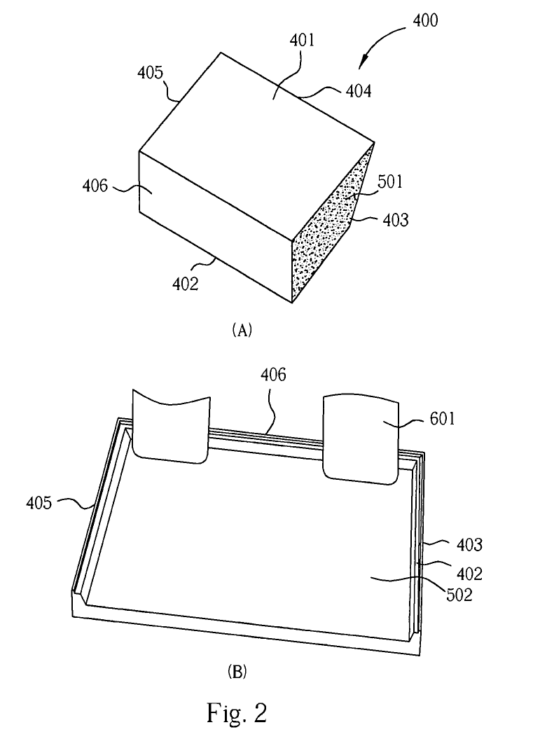

First, a chunk of bamboo laminate is provided. The bamboo laminate is utilized as one of the materials for the cover 101 of the notebook computer 100. As shown in FIG. 2(A), the bamboo laminate 400 comprises a first surface 401, a second surface 402, a first circumferential surface 403, a second circumferential surface 404, a third circumferential surface 405, and a fourth circumferential surface 406. According to the natural features of the bamboo laminate 400, the first surface 401, the second surface 402, the second circumferential surface 404, and the fourth circumferential surface 406 display a lengthwise woodgrain pattern of the bamboo laminate 400. Further, the first circumferential surface 403 and the third circumferential surface 405 display a transectional woodgrain pattern of the bamboo laminate 400 and expose dot-shaped bamboo vessels 501. The vessels 501 are natural structures contained in the bamboo laminate 400. Contrarily, woodgrain slices utilized by slice-veneering technology in the prior art cannot display any natural vessel as described above.

Next, as shown in FIG. 2(B), a computer numerical control (CNC) machine 601 is utilized to form a recess 502 on the second surface 402 of the bamboo laminate 400 by milling. In this embodiment, the first circumferential surface 403, the third circumferential surface 405, and the fourth circumferential surface 406 of the bamboo laminate 400 are reserved for the recess 502. Additionally, the second circumferential surface 404 of the bamboo laminate 400 is milled away, thereby providing the space for a connecting hinge which connects an upper cover (including the cover 101 and the display unit 102) of the notebook computer 100 to the system body 103. This is not meant to be a limitation of the present invention, however.

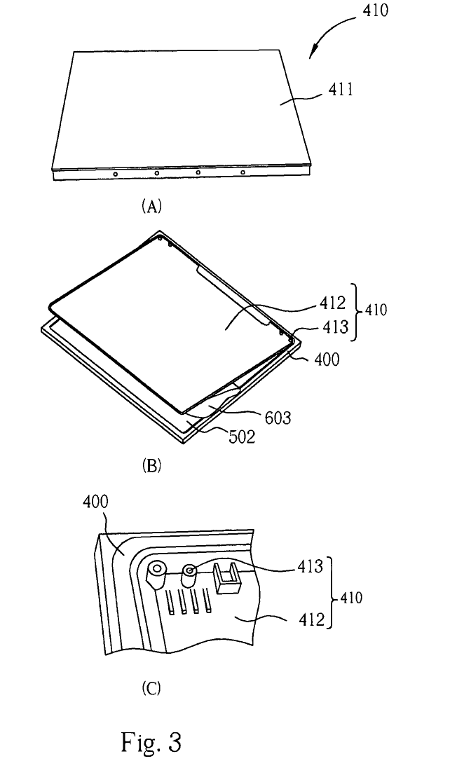

As shown in FIGS. 3(A)-3(B), a supporting component 410 is provided. An inner surface of the recess 502 is covered with an adhesive completely. In this embodiment, the adhesive is a twin adhesive film 603. Then, the supporting component 410 is adhesively attached into the recess 502. In this embodiment, a surface 411, of the supporting component 410, adhesively attached to the recess 502 has a shape corresponding to that of the inner surface of the recess 502, so the surface 411 can be tightly and seamlessly attached to the inner surface. The supporting component 410 can supply desired strength to the bamboo laminate 400 thinned by milling. Besides, as shown in a partial enlargement in FIG. 3(C), some connecting units 413 can be disposed on an exposed surface 412 of the supporting component 410 for connecting the supporting component 410 to the display unit 102 or other components (not shown in drawings) in future assemblage.

To improve intensity and tightness in adhesion, the supporting component 410 and the recess 502 adhesively attached together can be pressurized for some duration at this point. In this embodiment, a mold can be applied to the exposed surface 412 of the supporting component 410, and thus some pressure can be applied from above of the mold or from above of the bamboo laminate 400, thereby effectively eliminating undesired bubbles occurring in the twin adhesive film 603 and further improving intensity and tightness in adhesion.

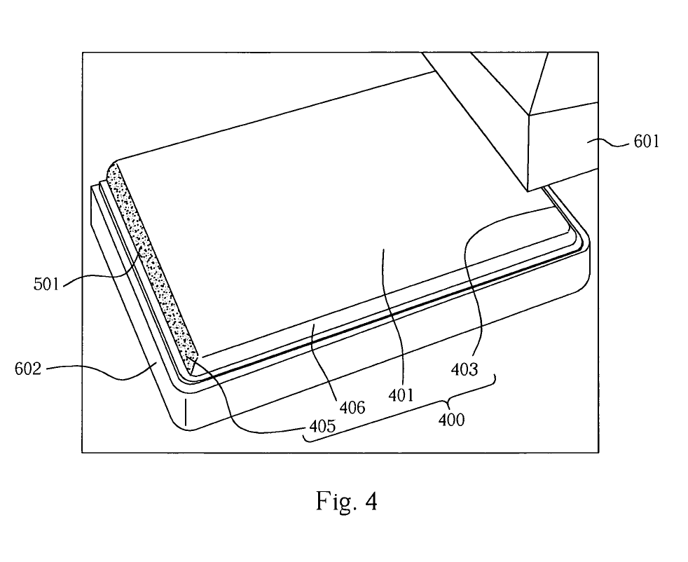

As shown in FIG. 4, a mold 602 is applied to the exposed surface 412 of the supporting component 410 as a supporter for the whole bamboo laminate 400. Then, the CNC machine 601 is utilized to mill the bamboo laminate 400 from the first surface 401. Additionally, the first surface 401, the first circumferential surface 403, the third circumferential surface 405, and the fourth circumferential surface 406 of the bamboo laminate 400 are all mill to a preset thickness, for example, between 0.3 mm and 1.5 mm. In this embodiment, the preset thickness is between 0.6 mm and 1.0 mm specifically. Thus, the electronic device can maintain lightness and slimness while the cover 101 can still achieve the purpose of protecting the electronic device.

Moreover, thicknesses of the first circumferential surface 403, the third circumferential surface 405, and the fourth circumferential surface 406 after cutting can be different from that of the first surface 401. Additionally, the first circumferential surface 403, the third circumferential surface 405, and the fourth circumferential surface 406 can be mill to form a right angle or an oblique angle with a preset obliquity according to the requirements. Specifically, in this embodiment, the first circumferential surface 403, the third circumferential surface 405, and the fourth circumferential surface 406 are cut to have a preset obliquity. With such obliquity, the edges of the cover 101 can be smoother, and a transection of the natural vessels 501 contained in the bamboo laminate 400 is much clear, thereby displaying craft features of the electronic device. Finally, as shown in FIG. 1(B), the cover 101 made of the bamboo laminate 400 can cover the supporting component 410 properly and completely in this embodiment. Thus, the supporting component 410 cannot be easily seen from the outside.

In this embodiment, the supporting component 410 is made of metals, plastic steels, or plastics. Additionally, the shapes and dimensions of the bamboo laminate 400 and the supporting component 410 as disclosed in this embodiment are merely one example of the present invention and thus are not meant to be a limitation of the present invention. In other words, the bamboo laminate 400 and the supporting component 410 can have any other feasible shapes and dimensions provided that the principles of the present invention are achieved. Moreover, although the electronic device disclosed in this embodiment is exemplified using a notebook computer, any other electronic devices (e.g. mobile phones or optical disc drives) having covers can become electronic devices having a bamboo appearance using the fabricating method disclosed in the present invention.

Those skilled in the art will readily observe that numerous modifications and alterations of the device and method may be made while retaining the teachings of the invention.

What is claimed is:

1. A fabricating method for a cover of a portable electronic device, comprising the following steps of:
(a) providing a chunk of timber laminate having an exterior circumferential surface, a first surface, and a second surface, and forming a recess on the second surface;
(b) attaching a supporting component into the recess; and
(c) cutting the first surface and the exterior circumferential surface to a preset thickness;
wherein the first surface and a portion of the exterior circumferential surface expose different woodgrain patterns.

2. The method of claim 1, wherein the timber laminate is a bamboo laminate.

3. The method of claim 1, wherein the portion of the exterior circumferential surface exposes a transectional woodgrain pattern of the timber laminate.

4. The method of claim 1, wherein the step (b) adhesively attaches the supporting component into the recess.

5. The method of claim 1, wherein the step (a) forms the recess by milling.

6. The method of claim 5, wherein the milling is performed by a computer numerical control (CNC) machine.

7. The method of claim 1, wherein the cutting in the step (c) is performed by a CNC machine.

8. The method of claim 1, wherein the supporting component is made of metals, plastic steels, or plastics.

9. The method of claim 1, wherein the preset thickness in the step (c) is between 0.3 mm and 1.5 mm.

10. A portable electronic device, comprising: a cover having a supporting component;
a display unit; and
a body having an input unit;
wherein the supporting component is disposed between the cover and the display unit, the display unit is electrically connected to the body, and the cover is fabricated by the following steps of:
(a) providing a chunk of timber laminate having an exterior circumferential surface, a first surface, and a second surface, and forming a recess on the second surface;
(b) attaching the supporting component into the recess; and
(c) cutting the first surface and the exterior circumferential surface to a preset thickness;
wherein the first surface and a portion of the exterior circumferential surface expose different woodgrain patterns.

11. The device of claim 10, wherein the portable electronic device is a notebook computer.

12. The device of claim 10, wherein the timber laminate is a bamboo laminate.

13. The device of claim 10, wherein the portion of the exterior circumferential surface exposes a transectional woodgrain pattern of the timber laminate.

14. The device of claim 10, wherein the step (b) adhesively attaches the supporting component into the recess.

15. The device of claim 10, wherein the step (a) forms the recess by milling.

16. The device of claim 15, wherein the milling is performed by a CNC machine.

17. The device of claim 10, wherein the cutting in the step (c) is performed by a CNC machine.

18. The device of claim 10, wherein the supporting component is made of metals, plastic steels, or plastics.

19. The device of claim 10, wherein the preset thickness in the step (c) is between 0.3 mm and 1.5 mm.
